(19) United States
(12) Patent Application Publication
(10) Pub. No.: US 2010/0094785 A1
(43) Pub. Date: Apr. 15, 2010

(54) SURVIVAL ANALYSIS SYSTEM, SURVIVAL ANALYSIS METHOD, AND SURVIVAL ANALYSIS PROGRAM

(75) Inventors: Yukiko Kuroiwa, Minato-ku (JP); Reiji Teramoto, Minato-ku (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Minato-ku, Tokyo (JP)

(21) Appl. No.: 12/530,428

(22) PCT Filed: Feb. 12, 2008
(86) PCT No.: PCT/JP2008/052226

§ 371 Date: Sep. 8, 2009

(30) Foreign Application Priority Data
Mar. 9, 2007 (JP) 2007-060409

(51) Int. Cl. G06F 15/18; G06N 5/02

(52) U.S. Cl. 706/12; 706/58

(57) ABSTRACT

Disclosed is a survival analysis system for determining an estimated time until an event occurs on the basis of a group of cases each including at least one attribute value indicating a feature value of a case and information on the measured actual time until an event occurs. The survival analysis system includes: an estimator creating section for creating an estimator for estimating whether or not an event occurs according to the attributes of the group of cases for each actual time; an estimator selecting section for judging whether or not the estimator meets a predetermined selection condition and to selecting an estimator used for calculating the estimated time; and a time calculating section for calculating the estimated time by using the estimator selected by the estimator selecting section.

### TECHNICAL FIELD

The present invention relates to a survival analysis system, a survival analysis method, and a survival analysis program which are used for analyzing the survival time of an individual or living thing or the lifespan of an industrial product.

### BACKGROUND ART

Survival analysis refers to the estimation of time until the occurrence of some irreversible event and the analysis of factors in the occurrence of the event. For example, survival analysis is used in clinical discipline to help in treatment by estimating the survival time of a group of patients stratified by observation conditions (feature values), such as certain symptoms, test results, drug administration, etc. and analyzing factors leading to death. Survival analysis can also be used to analyze the onset of a disease or the relapse of a disease, as well as a survival time. In addition, survival analysis can be applied to the analysis of failure factors in order to estimate time to failure of a machine and help in the improvement of stability of the machine, or can be applied to business management or the like for resorting to means for preventing cancellation prior to cancellation by estimating time to cancellation from a customer and analyzing factors leading to cancellation. In addition, stratification means that cases are classified into a plurality of groups according to their feature values.

In survival analysis, for a certain length of time, a case in which some target event occurs is referred to as a fatal case, a case in which the event does not occur is referred to as a survival case, and a case in which observation is censored before the occurrence of the event due to a cause not associated with the event is referred to as a censored case. Here, death or survival is not limited to the meaning of actual death or survival of a patient. For example, in case of analyzing the onset of some disease, for a certain length of time, a fatal case is a patient with the disease, a survival case is an individual who is under observation before onset of the disease, and a censored case is an individual who was under observation on whom the observation is censored due to accidental death, move, etc.

In conventional survival analysis, a technique of testing by stratifying cases according to the condition of predetermined factors of incidence is mainly used. For example, in Kaplan-Meier analysis, a group of patients with a certain disease is analyzed by using a survival curve on which the horizontal axis is the length of survival time and the vertical axis is cumulative survival probability. Here, in a censored case, cumulative survival probability is calculated under the assumption that a patient dies with the same probability as other diseases after being censored. Consequently, the cumulative survival probability simply decreases with time. Besides, in a log rank test, testing is performed on a plurality of patient groups satisfying multiple predetermined conditions about whether or not there is any statistically significant difference between the patient groups by using the mortality rate of the patients for each predetermined time point. If there is a significant difference, it is judged that the predetermined conditions were the factors in the incidence of the disease.

An example of a conventional survival analysis system using such survival analysis is disclosed in Japanese Laid-Open Patent Publication No. 2003-167959. In this survival analysis system of the first conventional example, prediction curve of healthy life expectancy for a plurality of groups of individuals who are under observation is created according to multiple predetermined conditions (smoking, drinking, obesity, hyperpiesia, hyperglycemia, hyperuricemia and so on) and the healthy life expectancy of an individual who takes a health diagnosis is predicted by the use of the prediction curve.

Additionally, another example of a conventional survival analysis system is disclosed in Japanese Laid-Open Patent Publication No. 2006-202235. In this survival analysis system of the second conventional example, a plurality of estimators for estimating the incidence rate of an event under analysis for each predetermined time point are provided, a phenomenon occurrence probability curve is created by using output values of the estimators, and the prognostic survival rate or survival time of a patient who develops the symptoms of some disease (like cancer), for example, is estimated.

However, the survival analysis system of the first conventional example, among the above conventional survival analysis systems, is complicated to operate and manipulate since someone needs to preliminarily stratify and input various conditions. In general, if the observation time is prolonged, the number of censored cases increases and the number of fatal cases and survival cases of individuals under observation decreases, thus leading to a tendency toward the degradation of reliability of a predicted value of healthy life expectancy. In the survival analysis system of the first conventional example, healthy life expectancy is estimated by using a predicted value for a long term with low reliability, equally with a predicted value for a short term with relatively high reliability, so that the time (estimated time) to event occurrence cannot be accurately obtained. Besides, the survival analysis system of the first conventional example has a problem in that since a person preliminarily sets various conditions, the factors in the incidence of an event that occurred, other than the factors preliminarily assumed by the person, cannot be found.

Meanwhile, in the survival analysis system of the second conventional example, the longer the observation time, the more difficult it is to create an estimator for accurately estimating the incidence rate of an event. Hence, an estimator of different performance is created for each predetermined time point. In the survival analysis system of the second conventional example, the survival time of a patient who develops symptoms, for example, is estimated by using such an estimator of low performance, equally with an estimator of high performance. Therefore, time (estimated time) to event occurrence cannot be accurately obtained. Further, in the survival analysis system of the second conventional example, the survival time of a patient who develops symptoms, for example, is estimated by using all of the incidence rates for each predetermined time point that are calculated by using a plurality of estimators. Thus, even if an event actually occurs (e.g., death of the patient who develops symptoms), it is difficult to specify the factors of incidence of the event.

### SUMMARY

Therefore, it is an exemplary object of the present invention to provide a survival analysis system and method which can estimate time to occurrence of an event relatively accurately.

It is another exemplary object of the present invention to provide a survival analysis system and method which can contribute to the finding of new factors in the incidence of an event.

In order to accomplish the above objects, the exemplary aspect of the invention provides a survival analysis system according to the present invention, which is for determining an estimated time until an event occurs on the basis of a group of cases each including at least one attribute value indicating a feature value of a case and information on the measured actual time until an event occurs, including: an estimator creating section for creating an estimator for estimating whether or not an event occurs according to the attributes of the group of cases for each actual time; an estimator selecting section for judging whether or not the estimator meets a predetermined selection condition and selecting an estimator used for calculating the estimated time; and a time calculating section for calculating the estimated time by using the estimator selected by the estimator selecting section.

Furthermore, there is provided a survival analysis method according to the present invention, which is for determining an estimated time until an event occurs on the basis of a group of cases each including at least one attribute value indicating a feature value of a case and information on the measured actual time until an event occurs, including: creating an estimator for estimating whether or not an event occurs according to the attributes of the group of cases for each actual time; judging whether or not the estimator meets a predetermined selection condition and selecting an estimator used for calculating the estimated time; and calculating the estimated time by using the estimator selected by the estimator selecting section.

### BRIEF DESCRIPTION OF THE DRAWINGS

FIG. 1 is a block diagram showing a configuration of a first exemplary embodiment of a survival analysis system of the present invention;

FIG. 2 is a block diagram showing one configuration example of a storage shown in FIG. 1;

FIG. 3 is a block diagram showing an implementation example of the survival analysis system shown in FIG. 1;

FIG. 4 is a flowchart showing a processing sequence of the survival analysis system shown in FIG. 1;

FIG. 5 is a block diagram showing a configuration of a second exemplary embodiment of a survival analysis system of the present invention; and

FIG. 6 is a flowchart showing a processing sequence of the survival analysis system shown in FIG. 5.

### EXEMPLARY EMBODIMENT

Next, the present invention will be described with reference to the accompanying drawings.

### First Exemplary Embodiment

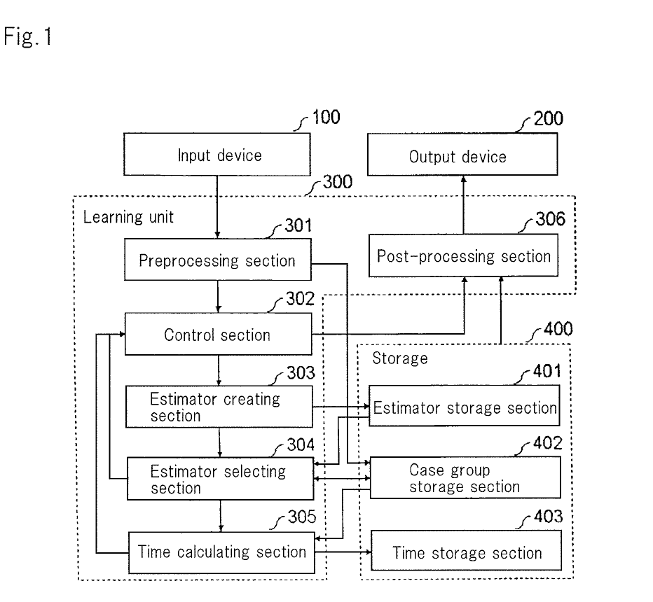

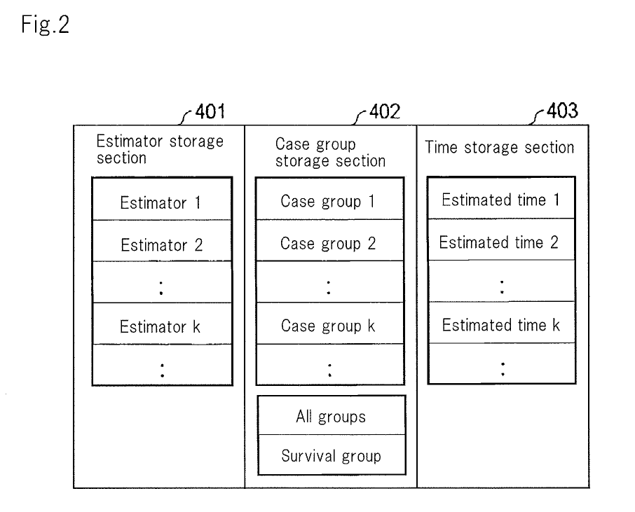

FIG. 1 is a block diagram showing a configuration of a first exemplary embodiment of a survival analysis system of the present invention. FIG. 2 is a block diagram showing one configuration example of a storage shown in FIG. 1.

The survival analysis system of the first exemplary embodiment is an example in which an estimator is created from input data of multiple groups of cases and information (output information) of a specific case desired by a user is created by using the estimator.

As shown in FIG. 1, the survival analysis system of the first exemplary embodiment comprises learning unit 300 for creating an estimator, corresponding to each group of cases, for estimating whether or not an event occurs, and for calculating a time to event occurrence by using the estimator, input device 100 for allowing a user to input data, such as a case, various conditions, etc., output device 200 for presenting processing results of learning unit 300 to the user, and storage 400 for storing the processing results of learning unit 300 and the case, various conditions, etc. inputted by the user.

As shown in FIG. 2, storage 400 comprises estimator storage section 401 for storing the estimator created in learning unit 300, case group storage section 402 for storing case groups inputted by the user, and time storage section 403 for storing an estimated time to the occurrence of an event corresponding to each case group. Here, the case group refers to a set of cases. Each case includes one or more attribute values, an actual time, and data of an event. The attribute values are values indicating the features (e.g., disease name, age, sex, daily habits, various test data, and so on) of the case, the actual time is an actual time (measured time) until an event (death or censoring) occurs, and the event is data representing a survival case, a fatal case, and a censored case. The estimated time is an estimate value of the survival time for each case calculated by learning unit 300 (time calculating section 305 to be described later).

Estimators 1˜k in estimator storage section 401, case groups 1˜k in case group storage section 402, and estimated times 1˜k in time storage section 403, as shown in FIG. 2, indicate that each item of data is sequentially arranged on an actual time basis in a time-series order. “all groups” in case group storage section 402 are storage areas storing all input case groups, and “survival group” is a storage area storing survival cases from all input case groups, excluding fatal cases and censored cases. Although FIG. 2 illustrates an example in which storage 400 is divided into estimator storage section 401, case group storage section 402, and time storage section 403 to store data of the estimators, case groups, and estimate times, respectively, data of the respective corresponding estimators, to case groups, and estimated times may be sequentially stored without dividing storage 400. Also, it may be possible to store ID numbers of the cases of the survival group and of the case groups in case group storage section 402, prepare a table or the like representing the correspondence relationship between the ID numbers and data of actual cases, and read data of each case with reference to the table upon execution of survival analysis.

Learning unit 300 includes preprocessing section 301, control section 302, estimator creating section 303, estimator selecting section 304, time calculating section 305, and post-processing section 306.

Preprocessing section 301 executes a predetermined preprocessing of each case group according to a case group and a specified condition that are inputted by the user from input unit 100, and stores the input case group and the pre-processed case group in case group storage section 402. The specified condition refers to an instruction inputted by the user by means of input device 100, and includes a learning parameter, a maximum time, which is an upper limit value of an actual time used for survival analysis, and so on.

Control section 302 determines whether to terminate survival analysis of the input case group. If it is determined to terminate, control section 302 makes transition to the processing by post-processing section 306, and if not, makes transition to the processing by estimator creating section 303.

Estimator creating section 303 creates an estimator for each of the case groups stored in a time-series order in case group storage section 402, and stores the created estimator corresponding to the case group in estimator storage section 401.

Estimator selecting section 304 selects an estimator used for calculating an estimated time, among the estimators created corresponding to the case groups stored in case group storage section 402, according to a predetermined selection condition.

The following are used as, for example, selection conditions for an estimator: a result of testing an estimation result by an estimator to be selected and an estimation result by an estimator corresponding to an actual time which is shorter than the actual time corresponding to the estimator and closest to the actual time and a result of testing an estimation result by an estimator to be selected and an estimation result by an estimator corresponding to an actual time which is longer than the actual time corresponding to the estimator and closest to the actual time.

Time calculating section 305 calculates time (estimated time) to event occurrence by using the estimator selected by estimator selecting section 304, and stores the calculated estimated time in time storage section 403.

Time calculating section 305 calculates an estimated time by using an actual time corresponding to an estimator and an actual time corresponding to another estimator which is shorter than the actual time corresponding to the estimator, among the actual times corresponding to the estimators selected by estimator selecting section 304. Otherwise, time calculating section 305 calculates an estimated time by using actual times of a group of cases where it is estimated that ‘no event occurs’ by an estimator corresponding to an actual time shorter than the actual time corresponding to another estimator which estimates that ‘event occurs’.

Post-processing section 306 generates output information (preset information or user-specified information) outputted by output device 200 on the basis of the estimators, case groups, and estimated times stored in storage 400, and supplies the generated output information to output device 200.

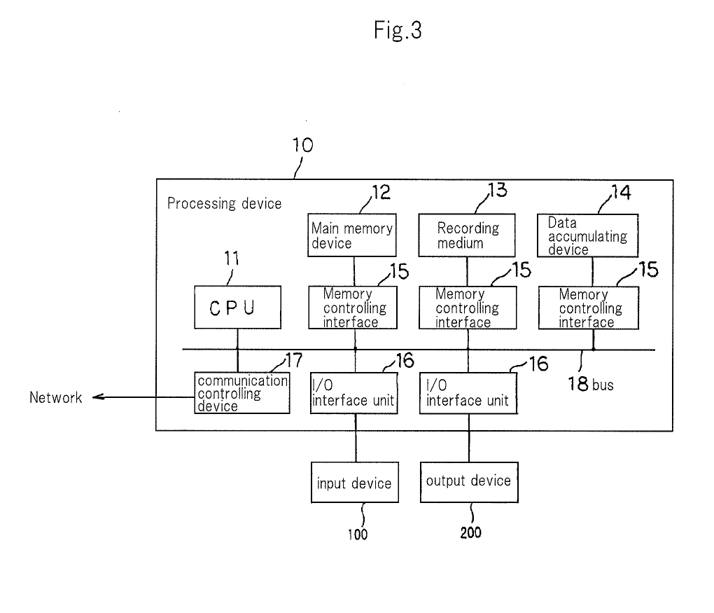

The survival analysis system of this exemplary embodiment can be implemented by a computer, for example. As shown in FIG. 3, the computer includes processing device 10 for executing a predetermined process according to a program, input device 20 for inputting a command, information or the like in processing device 10, and output device 30 for monitoring the processing result of processing device 10.

Processing device 10 includes CPU 11, main memory device 12 for temporally storing information required for processing by CPU 11, recording medium 13 for recording a program for causing CPU 11 to execute processing operations of learning unit 300, data accumulating device 14 for storing a case group and various conditions inputted from input device 100 by a user, estimators, estimated times, and so on, main memory device 12, memory controlling interface unit 15 for controlling data transfer with respect to recording medium 13 and data accumulating device 14, and I/O interface unit 16 as an interface unit for input device 20 and output device 30. CPU 11, memory controlling interface unit 15 and I/O interface unit 16 are connected via a bus 18. Processing device 1 may include communication controlling device 17 that is an interface for transmitting and receiving data to/from a network.

Processing device 10 implements functions of a learning unit according to a program recorded in recording medium 13. Recording medium 13 may be a magnetic disk, a semiconductor memory, an optical disk or other recording medium.

The survival analysis system of this exemplary embodiment is not limited to a configuration that is implemented by the computer shown in FIG. 3. The survival analysis system of this exemplary embodiment may be a configuration for implementing the functions of learning unit 300 or storage 400 by a semiconductor integrated circuit device, a memory, and so forth, such as an LSI (Large Scale Integration) and a DSP (Digital Signal Processor), comprised of a logical circuit or the like. While FIG. 3 illustrates the configuration in which data accumulating device 14 is provided in processing device 1, data accumulating device 14 may be provided separately from processing device 1.

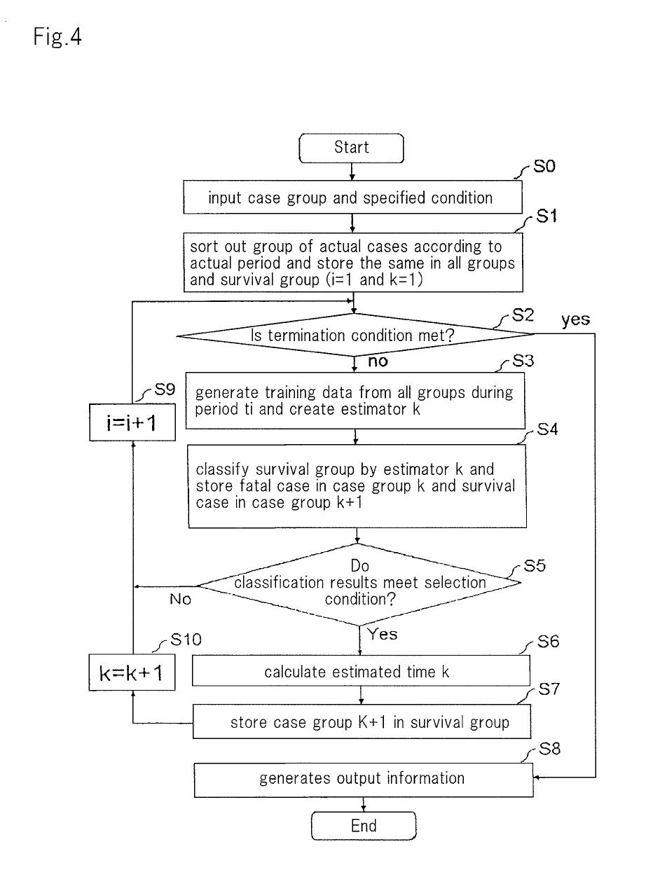

Next, an operation of the survival analysis system of the first exemplary embodiment will be described with reference to FIG. 4.

FIG. 4 is a flowchart showing a processing sequence of the survival to analysis system shown in FIG. 1.

As shown in FIG. 4, when a case group and a specified condition are inputted from input device 100 (step S0), learning unit 300 first sorts out the group of cases according to their actual times by means of preprocessing section 301, and stores the input case group in all groups and survival groups, respectively, of case group storage section 402. The groups of cases, after being sorted, are arranged in the order of actual times t₁, t₂, . . . , t_{N}.

In addition, preprocessing section 301 initializes the value i of code t₁ (i=1, 2, . . . , N) allocated to actual times of the group of cases to 0, simultaneously while removing redundant cases, and initializes a value of code k allocated to created estimators to 1 (step S1)

Also, if the survival analysis system have sufficient case groups, or if it is desired to shorten the processing time, preprocessing section 301 may sort out the input case group by using only cases in which an event is a fatal case among all the input cases, rather than the times of all of the input cases.

Moreover, if it is difficult to determine an estimated time since a time to event occurrence is a long time, or if it is practically meaningless to estimate time to event occurrence, it is possible to allow the user to input a maximum time, which is an upper limit value of an actual time used for survival analysis, as a specified condition and to exclude any cases exceeding the maximum time by preprocessing section 301 when sorting out the input case group.

Next, learning unit 300 judges whether or not a termination condition of survival analysis processing is met by means of control section 302 (step S2). If met, transition is made to the processing by post-processing section 306, or if not, transition is made to the processing by estimator creating section 303.

If the termination condition is not met, learning unit 300 generates training data used in the machine learning technique from data stored in all the groups of case group storage section 402 by means of estimator creating section 303, and creates an estimator corresponding to the case group of actual time tᵢ by using the training data. Estimator creating section 303 creates estimator k by use of a predetermined well-known technique or by use of the technique specified by the user by input device 100, and stores created estimator k in estimator storage section 401 (step S3). The training data is generated by labeling a case of death during actual time t₁ as a fatal case and labeling a case of survival during actual time tᵢ as a survival case, while excluding censored cases, observation of which was stopped before actual time tᵢ, and then using the attributes and labels. It is possible to generate an estimator by well-known machine learning techniques, such as a decision tree, a support vector machine, a neural network, etc.

Estimator selecting section 304 estimates whether or not an event occurs in the case groups stored in the survival group by using estimator k created by estimator creating section 303, and classifies the event groups as survival or death on the basis of estimation results. Estimator selecting section 304 stores a case group classified as death in case group k of case group storage section 402, and stores a case group classified as survival in case group k+1 of case group storage section 402 (step S4).

Also, estimator selecting section 304 judges whether or not estimator k created by estimator creating section 303 meets a predetermined selection condition according to these classification results (step S5). If the selection condition is not met, 1 is added to i of actual time tᵢ (step S9), and the flow returns to the processing of step S2 to repeat the processes of steps S2 to S5. Further, if estimator k meets the selection condition, transition is made to the processing by time calculating section 305.

While this exemplary embodiment illustrates an example of increasing i by 1, if it is desired to shorten the processing time because of a large number of cases, i may be increased in numerical units of actual times specified by the user, i.e., in units of numbers specified by the user.

Selection of an estimator by estimator selecting section 304 is performed on the basis of a result of a test process of case group k−1 and case group k and a result of a test process of case group k and case group k+1. As the selection condition, a preset condition or a condition inputted by the user by input device 100 is used.

Concrete examples of the selection condition include any one of the following conditions:

(Condition A) a condition in which there is a statistically significant difference between the two groups as the result of the test process of case group k−1 and case group k;

(Condition B) a condition in which there is a statistically significant difference between the two groups as the result of the test process of case group k and case group k+1;

(Condition C) a condition in which the number of case group k is a preset number or a user-specified number or more;

(Condition D) a condition in which the number of cases of case group k with respect to the total number of cases is a preset ratio or user-specified ratio or more; and

(Condition E) a condition in which both of the number of cases of case group k classified as a fatal case and the number of cases of case group k+1 classified as a survival case are 1 or more,

or a combination of these conditions.

The test process includes, for example, a log rank test or a median test using only cases where an event in the case groups is death. In case of using the log rank test as the test process, it is preferable to use a selection condition of “the above conditions A and B are met” or “the above conditions A and B are met, or the above condition D is met”.

However, an estimator is not always capable of accurately estimating the occurrence of an event as discussed above. If an estimate error occurs to an estimator corresponding to a case, this exerts an adverse effect on the testing of another estimator corresponding to a case having an actual time longer than the above case has. For example, since a time to event occurrence is long, if a number of cases are estimated incorrectly as fatal cases by estimator k−1, there may be no statistically significant difference between two groups in a testing process even if the performance of estimator k having a long actual time is excellent. The same applies to when a case with a short time to event occurrence is classified incorrectly as a survival case by estimator k−1.

To prevent the effect of such an estimate error of estimator k−1, estimator selecting section 304 may exclude cases with time to event occurrence longer than actual time tᵢ₋₁ from case group k−1 stored in case group storage section 402 and exclude cases with time to event occurrence shorter than actual time tᵢ₋₁ from case group k stored in case group storage section 402.

Time calculating section 305 calculates estimated time k, which is a time to event occurrence, corresponding to case group k by using the estimator selected by estimator selecting section 304, and stores it in time storage section 403 of storage 400 (step S6). Estimated time k is estimated, for example, by using any one of the following conditions:

(Condition F) a condition in which estimated time k is an average value of actual time tᵢ₋₁ and actual time tᵢ;

(Condition G) a condition in which estimated time k is an average value of estimated time k−1 and actual time tᵢ;

(Condition H) a condition in which estimated time k is a median value of the time to event (death) occurrence of case group k; and

(Condition I) a condition in which estimated time k is an average value of the time to event (death) occurrence of case group k.

Here, as for a censored case where time to event occurrence is longer than the maximum value of an actual time of a fatal case, it is preferable to use a condition in which the censored case is assumed to be a fatal case at the time point of censoring and in which “time to event (death) occurrence” of the aforementioned conditions H and I is substituted to “time to event (death) occurrence and time to event occurrence of a censored case longer than the maximum time of a fatal case”.

When the estimated time of case group k is calculated by time calculating section 305, learning unit 300 stores case group k+1 classified as survival in the survival group of case group storage section 402 by means of control section 302 (step S7), adds 1 to k (step S10), adds 1 to i (step S9), returns to the process of step S2, and repeats the processes of steps S2 to S9.

If the termination condition is met in the process of step S2 by control section 302, learning unit 300 generates preset or user-specified output information by means of post-processing section 306, passes the output information to output device 200, and then terminates the process (step S8). The output information includes, for example, data such as estimator k or estimated time k stored in storage 400. Also, analysis data such as survival curves of a group of cases or test results of the group of cases can be outputted by a user's instruction.

While this exemplary embodiment illustrates the processing sequence of generating an estimator and selecting the created estimator, it is also possible to sequentially select estimators in the order of cases that have shorter actual times after creating all estimators. Also, although this exemplary embodiment illustrates an example where a case includes at least one attribute value, an actual time, and an event, if all events are fatal cases, a case including only an attribute and a time may be used.

Furthermore, it may be also possible to verify the effectiveness of an estimator and incorporate a result of the verification in the output information. Methods for verifying the effectiveness of an estimator include a method using a survival curve obtained by the above-mentioned Kaplan-Meier analysis, or a method using a test value obtained by a log rank test or median test used in the test process.

According to the survival analysis system of the first exemplary embodiment, a plurality of estimators can be automatically created, and fine stratification can be automatically performed on a group of cases corresponding to an estimated time. Further, since an estimated time is determined by using an estimator capable of relatively accurate prediction, among the plurality of estimators according to a predetermined selection condition, time to event occurrence can be comparatively accurately estimated.

Moreover, since an estimated time and an estimator can correspond to each other, it is possible to find new factors in the incidence of an event corresponding to the estimated time by analyzing the condition of the estimator. Consequently, there is provided a survival analysis system which contributes to the finding of new factors in the incidence of an event.

### Second Exemplary Embodiment

Next, a second exemplary embodiment of the survival analysis system of the present invention will be described with reference to the drawings.

The survival analysis system of the second exemplary embodiment is an example in which estimators are previously created from data of a plurality of preliminarily input case groups, and estimated times corresponding to these estimators are previously calculated and preliminarily stored. In this case, desired information (output information) is outputted by a user's inputting a specific case or various conditions.

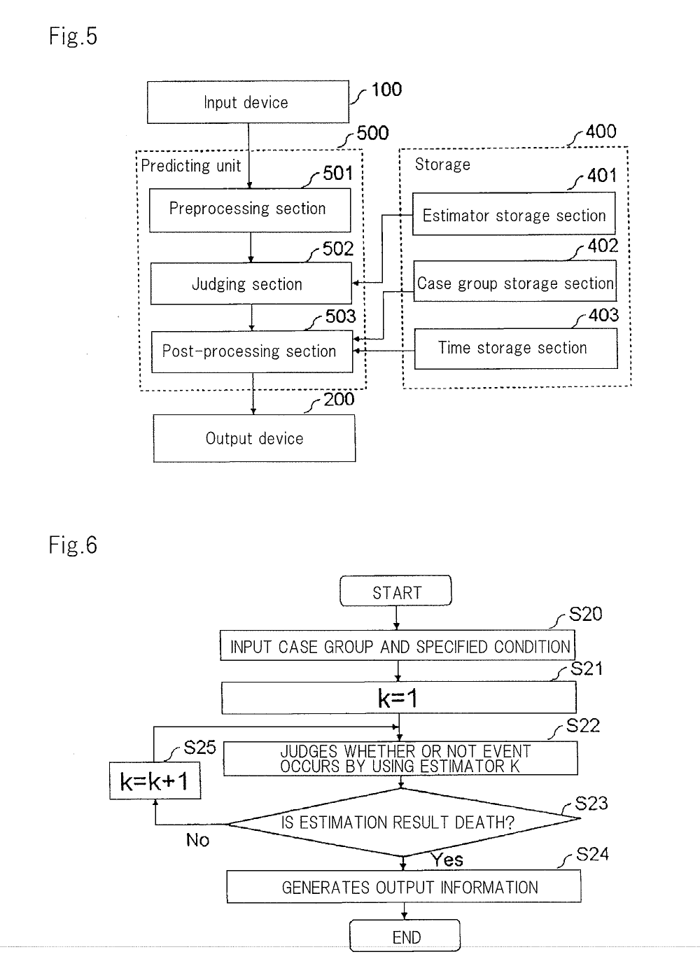

FIG. 5 is a block diagram showing a configuration of a second exemplary embodiment of a survival analysis system of the present invention.

As shown in FIG. 5, the survival analysis system of the second exemplary embodiment comprises predicting unit 500 for judging whether or not an event occurs by using a previously created estimator corresponding to each case group, input device 100 for allowing a user to input data, such as a case, various conditions, etc., output device 200 for presenting processing results of predicting unit 500 to the user, and storage 400 for storing the processing results of predicting unit 500 and the case, various conditions, etc. inputted by the user.

Since the configurations and operations of input device 100, output device 200, and storage 400 are identical to those in the first exemplary embodiment, a description thereof will be omitted.

As in the first exemplary embodiment, storage 400 comprises estimator storage section 401 for storing a previous created estimator, case group storage section 402 for storing case groups inputted by the user, and time storage section 403 for storing an estimated time to the occurrence of an event corresponding to each case group.

Estimators 1˜k in estimator storage section 401, case groups 1˜k in case group storage section 402, and estimated times 1˜k in time storage section 403, as in the first exemplary embodiment, indicate that each item of data is sequentially arranged on an actual time basis in a time-series order.

Predicting unit 500 includes preprocessing section 501, judging section 502, and post-processing section 503.

Preprocessing section 501 executes a predetermined preprocessing of each case group according to a case group and a specified condition that are inputted by the user from input unit 100, and stores the input case group and the pre-processed case group in case group storage section 402.

Judging section 502 judges whether or not an event occurs by using the estimators stored in estimator storage section 401 and corresponding to the preprocessed case. Also, judging section 502 judges that the shortest actual time of the actual times corresponding to estimators which estimate that ‘event occurs’ is an estimated time to the event occurrence.

Post-processing section 503 reads an actual time corresponding to an estimator extracted by 502 from time storage section 403, and outputs it as an estimated time.

Like the first exemplary embodiment, the survival analysis system of the second exemplary embodiment may be implemented by a semiconductor integrated circuit device, a memory, and so forth, such as an LSI and a DSP, comprised of a computer or a logical circuit or the like as shown in FIG. 3.

Next, an operation of the survival analysis system of the second exemplary embodiment will be described with reference to FIG. 6.

FIG. 6 is a flowchart showing a processing sequence of the survival analysis system shown in FIG. 5.

As shown in FIG. 6, when a case group and a specified condition are inputted from input device 100 (step S20), predicting unit 500 first initializes the value of code k allocated to estimators to 1 (step S21). Here, the actual time of a case and the value of an event may be unknown. Also, even if part of an attribute value is unknown (missing value), missing data may be interpolated by use of a well-known interpolation technique (average interpolation, median interpolation, etc.). A specified condition of whether or not a survival curve is indicated is inputted from the user by using input to device 100.

Judging section 502 judges, as regards a preprocessed case, whether or not an event (survival or death) occurs by using estimator k corresponding to estimator storage section 401 (step S22). Also, it is judged whether an estimation result is death or not (step S23). If a judging result is survival, 1 is added to k (step S25), returns to the process of step S22, and repeats the processes of steps S22 and S24. On the other hand, if the judging result is death, it is judged that estimator k corresponds to the case.

Post-processing section 503 reads estimated time k corresponding to estimator k judged to correspond to the case under analysis from time storage section 403 of storage 400, outputs estimated time k as output information (step S24), and then terminates the process.

Meanwhile, post-processing section 503 may incorporate analysis data, such as survival curves or test process results of case group k, in the output information by using estimator k stored in estimator storage section 401, a condition corresponding to the case corresponding to estimator k, and the case group stored in time storage section 403. The analysis data of case group k may be preliminarily created and stored in storage 400.

Although the above description has illustrated an example of outputting an estimated time to event occurrence by using a corresponding estimator with respect to one input case, it may also be possible to input a plurality of cases (case group) from input device 100, calculate estimated times to the event occurrence of the plurality of cases, perform a predetermined statistical processing on them, and then output information about the input case group.

Further, the survival analysis system of the second exemplary embodiment may be provided separately from the survival analysis system of the first exemplary embodiment.

According to the survival analysis system of the second exemplary embodiment, an estimated time and an estimator that estimates that death occurs, correspond to each other, and information of the estimator is outputted according to a specified condition from the user, the factors in the incidence of an event corresponding to the case can be easily analyzed.

This application is based upon and claims the benefit of priority from Japanese patent application No. 2007-060409, filed on Mar. 9, 2007, the disclosure of which is incorporated herein in its entirety by reference.

1. A survival analysis system, which is for determining an estimated time until an event occurs on the basis of a group of cases each including at least one attribute value indicating a feature value of a case and information on the measured actual time until an event occurs, comprising:
an estimator creating section creating an estimator for estimating whether or not an event occurs according to the attributes of said group of cases for each actual time;
an estimator selecting section judging whether or not said estimator meets a predetermined selection condition and selecting an estimator used for calculating said estimated time; and
a time calculating section calculating said estimated time by using the estimator selected by said estimator selecting section.

2. The survival analysis system according to claim 1, wherein said case is provided with information of an event indicating whether or not an event occurs or whether or not a case of censored observation occurs, and
said estimator creating section creates said estimator from the attributes of the remaining cases of the group excluding censored cases in said actual time.

3. The survival analysis system according to claim 2, wherein said estimator selecting section uses, as a selection condition for judging whether or not to use an estimator to be selected for the calculation of said estimated time, a result of testing an estimation result by an estimator to be selected and an estimation result by an estimator corresponding to an actual time which is shorter than the actual time corresponding to the estimator and which is closest to the actual time, and a result of testing an estimation result by an estimator to be selected and an estimation result by an estimator corresponding to an actual time which is longer than the actual time corresponding to the estimator and which is closest to the actual time.

4. The survival analysis system according to claim 1, wherein said time calculating section calculates said estimated time by using an actual time corresponding to an estimator and an actual time corresponding to another estimator which is shorter than the actual time corresponding to the estimator, among the actual times corresponding to the estimators selected by said estimator selecting section.

5. The survival analysis system according to claim 4, wherein said time calculating section sets said estimated time to an average value between an actual time corresponding to an estimator and an actual time corresponding to another estimator which is shorter than the actual time corresponding to the estimator and which is closest to the actual time, among the actual times corresponding to the estimators selected by said estimator selecting section.

6. The survival analysis system according to claim 1, wherein said time calculating section calculates an estimated time by using actual times of a group of cases where it is estimated that ‘no event occurs’ by an estimator corresponding to an actual time shorter than the actual time corresponding to another estimator used for calculating the estimated time and it is estimated that ‘event occurs’ by the estimator used for calculating the estimated time.

7. The survival analysis system according to claim 6, wherein said time calculating section sets the estimated time to either the average value or median value between the actual times of the group of the cases where it is estimated that ‘no event occurs’ by an estimator corresponding to an actual time shorter than the actual time at the time point of creation of another estimator used for calculating the estimated time and it is estimated that ‘event occurs’ by the estimator used for calculating the estimated time.

8. The survival analysis system according to claim 1, further comprising a post-processing section generating output information to be presented to the user, including one or more from among a calculation result of the estimated time, analysis data of said group of cases, and a test result of the effectiveness of said estimator.

9. A survival analysis system, comprising:
a plurality of estimators estimating whether or not an event occurs from an attribute value included in an input case and indicating a feature value of the case;
a judging section judging that the shortest actual time of the actual times corresponding to estimators which estimate that ‘event occurs’ is an estimated time to the event occurrence; and
a post-processing section generating output information including the estimated time and/or information of the estimator corresponding to the estimated time.

10. The survival analysis system according to claim 9, wherein said post-processing section generates output information including a feature value of a case group corresponding to the input case.

11. A survival analysis method, which is for determining an estimated time until an event occurs on the basis of a group of cases each including at least one attribute value indicating a feature value of a case and information on the measured actual time until an event occurs, comprising:
creating an estimator estimating whether or not an event occurs according to the attributes of said group of cases for each actual time;
judging whether or not the estimator meets a predetermined selection condition and selecting an estimator used for calculating the estimated time; and
calculating said estimated time by using the estimator selected by said estimator selecting section.

12. The survival analysis method according to claim 11, wherein the case is provided with information of an event indicating whether or not an event occurs or whether or not a case of censored observation occurs, and
said estimator is created from the attributes of the remaining cases of the group excluding censored cases in said actual time.

13. The survival analysis method according to claim 12, wherein, as a selection condition judging whether to use an estimator to be selected for the calculation of the estimated time or not, used are a result of testing an estimation result by an estimator to be selected and an estimation result by an estimator corresponding to an actual time which is shorter than the actual time corresponding to the estimator and which is closest to the actual time, and a result of testing an estimation result by an estimator to be selected and an estimation result by an estimator corresponding to an actual time which is longer than the actual time corresponding to the estimator and which is closest to the actual time.

14. The survival analysis method according to claim 11, wherein said estimated time is calculated by using an actual time corresponding to an estimator and an actual time corresponding to another estimator which is shorter than the actual time corresponding to the estimator, among the actual times corresponding to the estimators selected by said estimator selecting section.

15. The survival analysis method according to claim 14, wherein said estimated time is set to an average value between an actual time corresponding to an estimator and an actual time corresponding to another estimator which is shorter than the actual time corresponding to the estimator and which is closest to the actual time, among the actual times corresponding to the estimators selected by said estimator selecting section.

16. The survival analysis method according to claim 11, wherein an estimated time is calculated by using actual times of a group of cases where it is estimated that ‘no event occurs’ by an estimator corresponding to an actual time shorter than the actual time corresponding to another estimator used for calculating the estimated time and it is estimated that ‘event occurs’ by the estimator used for calculating the estimator.

17. The survival analysis method according to claim 16, wherein the estimated time is set to either the average value or median value between the actual times of the group of the cases where it is estimated that ‘no event occurs’ by an estimator corresponding to an actual time shorter than the actual time at the time point of creation of another estimator used for calculating the estimated time and it is estimated that ‘event occurs’ by the estimator used for calculating the estimated time.

18. The survival analysis method according to claim 11, wherein output information to be presented to the user is generated, including at least one from among the following: a calculation result of said estimated time, analysis data of said group of cases, and a test result of the effectiveness of said estimator.

19. A survival analysis method, comprising:
having a plurality of estimators estimating whether or not an event occurs from an attribute value included in an input case and indicating a feature value of the case;
judging that the shortest actual time of the actual times corresponding to estimators which estimate that ‘event occurs’ is an estimated time to the event occurrence; and
generating output information including at least one from among the estimated time and information of the estimator corresponding to the estimated time.

20. The survival analysis method according to claim 19, wherein output information is generated, including a feature value of a case group corresponding to the input case.

21. A recording medium storing a program, which is for executing, by a computer, a process for determining an estimated time until an event occurs on the basis of a group of cases each including at least one attribute value indicating a feature value of a case and information on the measured actual time until an event occurs, wherein the program causes the computer to execute the processes for:
creating an estimator estimating whether or not an event occurs according to the attributes of said group of cases for each actual time;
judging whether or not said estimator meets a predetermined selection condition and selecting an estimator used for calculating said estimated time; and
calculating said estimated time by using said selected estimator.

22. The recording medium storing the program according to claim 21, wherein said case is provided with information of an event indicating whether or not an event occurs or whether or not a case of censored observation occurs, and
the program causes the computer to execute the process creating said estimator from the attributes of the remaining cases of the group excluding censored cases in said actual time.

23. The recording medium storing the program according to claim 22, wherein the program causes the computer to execute the process for using, as a selection condition judging whether to use an estimator to be selected for the calculation of the estimated time or not, a result of testing an estimation result by an estimator to be selected and an estimation result by an estimator corresponding to an actual time which is shorter than the actual time corresponding to the estimator and which is closest to the actual time, and a result of testing an estimation result by an estimator to be selected and an estimation result by an estimator corresponding to an actual time which is longer than the actual time corresponding to the estimator and which is closest to the actual time.

24. The recording medium storing the program according to claim 21, wherein the program causes the computer to execute the process calculating the estimated time by using an actual time corresponding to an estimator and an actual time corresponding to another estimator which is shorter than the actual time corresponding to the estimator, among the actual times corresponding to said selected estimators.

25. The recording medium storing the program according to claim 24, wherein the program causes the computer to execute the process setting the estimated time to an average value between an actual time corresponding to an estimator and an actual time corresponding to another estimator which is shorter than the actual time corresponding to the estimator and which is closest to the actual time, among the actual times corresponding to said selected estimators.

26. The recording medium storing the program according to claim 21, wherein the program causes the computer to execute the process calculating an estimated time by using actual times of a group of cases where it is estimated that ‘no event occurs’ by an estimator corresponding to an actual time shorter than the actual time corresponding to another estimator used for calculating the estimated time and it is estimated that ‘event occurs’ by the estimator used for calculating the estimator.

27. The recording medium storing the program according to claim 26, wherein the program causes the computer to execute the process setting the estimated time to either the average value or median value between the actual times of the group of the cases where it is estimated that ‘no event occurs’ by an estimator corresponding to an actual time shorter than the actual time at the time point of creation of another estimator used for calculating the estimated time and it is estimated that ‘event occurs’ by the estimator used for calculating the estimated time.

28. The recording medium storing the program according to claim 21, wherein the program causes the computer to execute the process of generating output information to be presented to the user, including at least one from among the following: a calculation result of the estimated time, analysis data of the group of cases, and a test result of the effectiveness of the estimator.

29. A recording medium storing a program, wherein the program causes a computer to execute the processes for:
having a plurality of estimators estimating whether or not an event occurs from an attribute value included in an input case and indicating a feature value of the case;
judging that the shortest actual time of the actual times corresponding to estimators which estimate that ‘event occurs’ is an estimated time to the event occurrence; and
generating output information including at least one from among said estimated time and information of the estimator corresponding to the estimated time.

30. The recording medium storing the program according to claim 29, wherein the program causes the computer to execute the process generating output information, including a feature value of a case group corresponding to the input case.
